(19) United States
(12) Patent Application Publication
(10) Pub. No.: US 2017/0225589 A1
(43) Pub. Date: Aug. 10, 2017

(54) Software-defined vehicular powertrain and method of operation

(71) Applicants: Shivinder Singh SIKAND, Santa Cruz, CA (US); Dean DRAKO, Austin, TX (US)

(72) Inventors: Shivinder Singh SIKAND, Santa Cruz, CA (US); Dean DRAKO, Austin, TX (US)

(21) Appl. No.: 15/499,883

(22) Filed: Apr. 27, 2017

Related U.S. Application Data
(63) Continuation-in-part of application No. 14/809,246, filed on Jul. 26, 2015, now abandoned.
(60) Provisional application No. 62/185,796, filed on Jun. 29, 2015.

(51) Int. Cl. B60L 15/02; B60L 11/18; G06F 13/40; B60K 1/02; H04L 29/06; G06F 13/42; B60L 15/20; B60L 7/14

(52) U.S. Cl. CPC B60L 15/025; B60L 15/2045; B60L 11/1803; B60L 7/14; B60K 1/02; H04L 63/0428; G06F 13/4282; G06F 13/4068; B60L 2210/44; B60L 2220/46; B60L 2240/423; B60L 2240/429; G06F 2213/0042

(57) ABSTRACT

A software-defined powertrain transmits commands to at least 4 distributed polyphase motor controllers. A single vehicle control unit transforms operator control indicia into a plurality of individual commands, and securely transmits said commands to each one of a plurality of independent motor controllers mechanically coupled to a single wheel by a polyphase electric motor. The motor controllers are DC to variable AC electrical converters which each receives phase and magnitude requirements. A mixed criticality operating system provides an encrypted application-programming interface to operate functions such as torque vectoring, cooling, braking, and battery management. The OS provides an isolated trust zone to each of a plurality of cores for authentication and validation.

### CROSS-REFERENCES TO RELATED APPLICATIONS

This is a continuation in part application that benefits from application Ser. No. 14/809,246 which is incorporated by reference. This non-provisional application benefits from Ser. No. 62/185,796 filed 29 Jun. 2015 which is incorporated,by reference in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

Technical Field

Vehicle control and torque distribution.

Description of the Related Art

As is known, (Faccioli of Schenectady N.Y., U.S. Pat. No. 949,320 February 1910) “Variable-Frequency Generators . . . to provide a self-exciting alternating-current . . . at frequencies which may be varied over a wide range . . . finds a useful application in supplying current to induction motors for driving cars, locomotives, or other mechanisms which are to be driven at variable speeds.”

Vector control and direct torque control (DTC), adjust the motor voltage magnitude, angle from reference, and frequency so as to precisely control the motor's magnetic flux and mechanical torque. What is needed is a federalized system of independently sovereign vehicle functions protected from mutual interference by isolated cores and virtualized communication channels.

### BRIEF SUMMARY OF THE INVENTION

A software-defined powertrain transmits commands to at least 4 distributed polyphase motor controllers. A modular vehicle control unit (VCU) includes a multi core CPU coupled to a non-transitory instruction store causing the CPU to perform running a mixed criticality OS; a security layer based on isolated trust zone cores of the multi-core CPU; an encryption/decryption channel to transmit and receive data and controls over a secure vehicle control network; an energy store management module; an energy store interface; an operator control interface; a sensor interface; and a torque-vectoring module. The vehicle control unit transforms operator control indicia into a plurality of individual commands, and securely transmits said commands to each independent motor controller mechanically coupled to a single wheel by a polyphase electric motor. The motor controllers are DC to variable AC electrical converters which each receives phase and magnitude requirements.

A system for operation of a vehicle having at least 4 inverters; each inverter coupled to, an energy store; the energy store and each inverter further coupled to, a single vehicle control unit (VCU); the VCU further coupled to both, an operator control interface circuit; and a plurality of sensors.

The VCU is a computer adapted to emit either a desired torque, or alternately, a desired AC current frequency and magnitude for each inverter by transforming indicia received from at least one sensor and from the operator control interface.

The software-defined powertrain enables a vehicle subsystem to be independently improved without interfering with the operation of other subsystems.

A real-time USB 2 or real time USB 3 or real time Ethernet backbone couples a plurality of local client hubs to a single vehicle control unit. Each client hub only has an encryption/decryption engine, and a PHY modem coupled to a layer 2 real-time USB 2 or real time USB 3 or Ethernet interface. The vehicle control unit creates a trust zone for each app and manages traffic across the backbone. Non-trivial computing is performed by a central containerized platform. This includes diagnostics for failures as well as malicious intrusion detection.

A single vehicle control unit transforms operator control indicia into a plurality of individual commands, and securely transmits said commands to actuators and control devices. An operating system provides an encrypted application-programming interface to operate functions such as torque vectoring, cooling, braking, and battery management. The OS provides an isolating trust zone to each layer or application for authentication and validation. Upgrades are available to install new features or improvements after a vehicle is in the field.

### BRIEF DESCRIPTION OF THE SEVERAL VIEWS OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1-2 are system block diagrams of components in a vehicle control system;

FIG. 3-4 is a data flow diagram of components in a secure network; and

FIG. 5 -6 is a block diagram of software components shown as a rotated stack.

### DETAILED DISCLOSURE OF EMBODIMENTS OF THE INVENTION

Selectable software defined powertrain modules determine responsiveness of a vehicle to its operator influences. All handling aspects reflect centrally stored parameters that affect each wheel separately.

A single vehicle control unit transforms operator control indicia into a plurality of individual commands, and securely transmits said commands to each one of a plurality of independent motor controllers mechanically coupled to a single wheel by a polyphase electric motor. Within the vehicle control unit is a virtual CPU (VCPU) scheduler that integrates the management of tasks and device interrupts. A collection of bandwidth-preserving servers provides predictable and efficient management of tasks and interrupts. A budget management scheme in which VCPUs are scheduled on PCPUs and thread are scheduled on VCPUs.

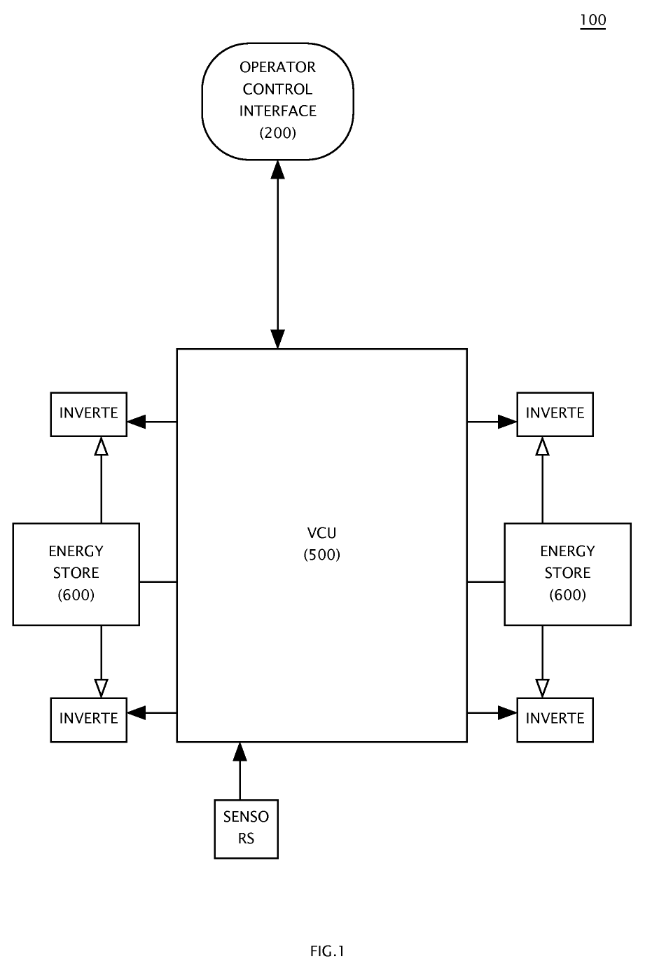

Referring now to FIG. 1: A system 100 for operation of a vehicle, includes at least 4 inverters 701-704; each inverter coupled to, an energy store 600; the energy store and each inverter further coupled to, a single vehicle control unit (VCU) 500; the VCU further coupled to both, an operator control interface circuit (200); and a plurality of sensors (300).

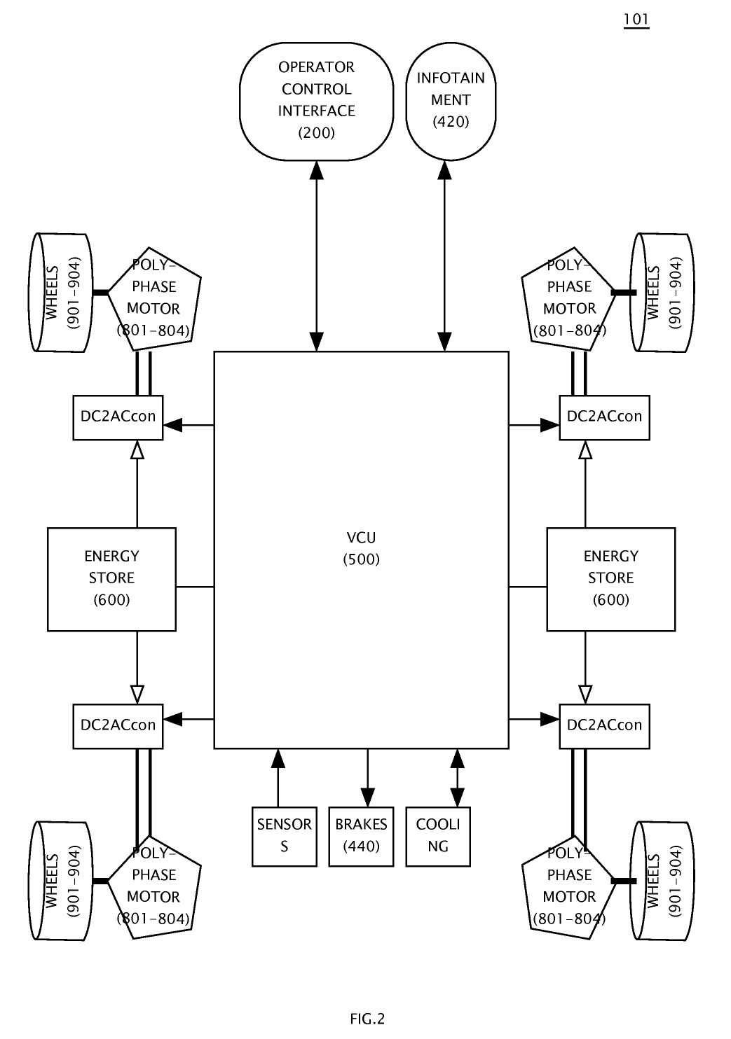

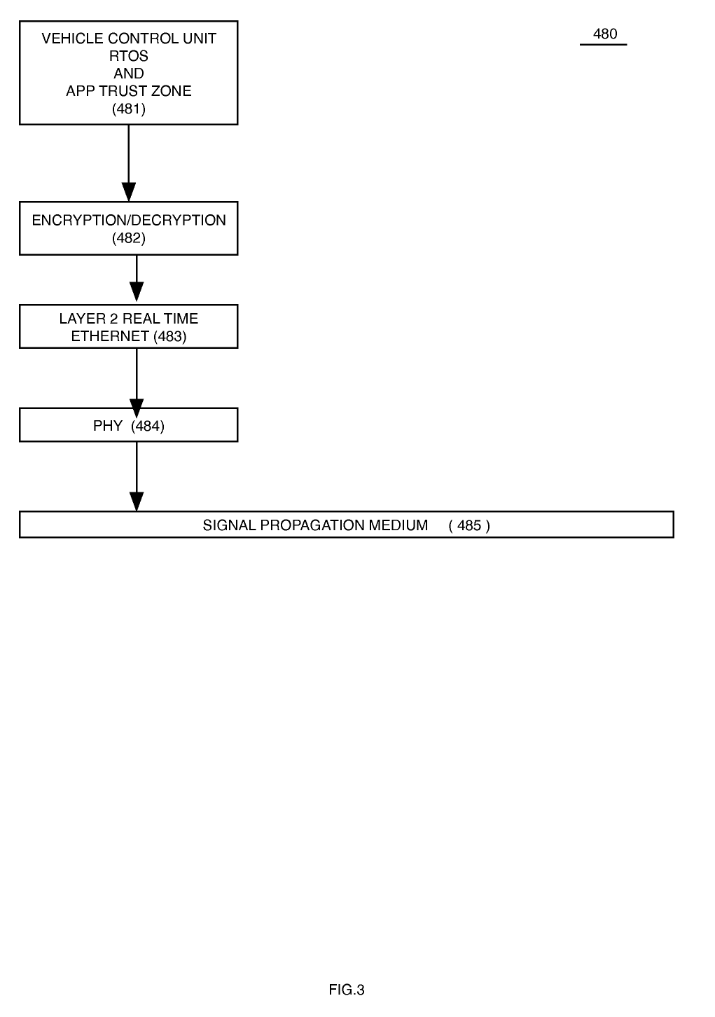

The four or more motor controllers are DC to variable AC electrical converters which each receives phase and magnitude requirements. Referring now to FIG. 2 in an embodiment, 101 each of the four or more inverters is a DC to AC converter 705-708; each said DC to AC converter coupled to a polyphase electric motor 801-804 which propels an individual wheel 901-904.

To address the congestion and security challenges of conventional CAN bus technology, the present invention provides a secure real-time USB 2 or real time USB 3 or real time Ethernet channel. Referring now to FIG. 3, an exemplary secure vehicle control network 480 includes a medium 485; the medium coupled to, a PHY circuit 484; the PHY circuit coupled to, a layer 2 real-time USB 2 or real time USB 3 or real time Ethernet circuit controller 483; coupled to an encryption/decryption circuit (coder) 482; and, the coder coupled to, a vehicle control unit 481 comprising a processor performing a real time operating system and trust zone layer.

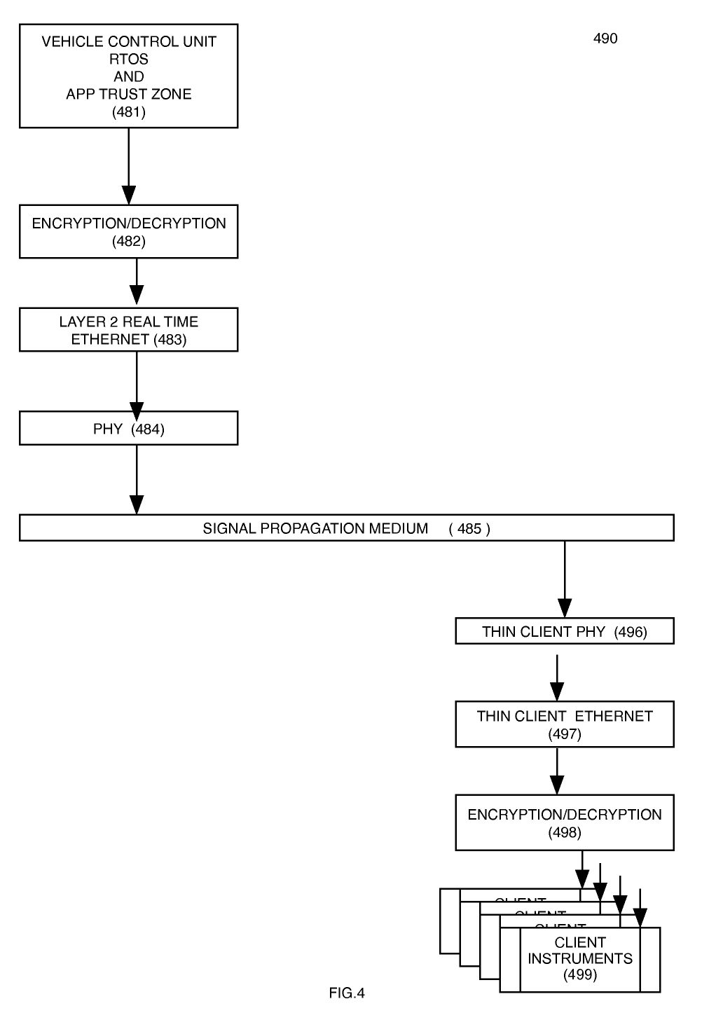

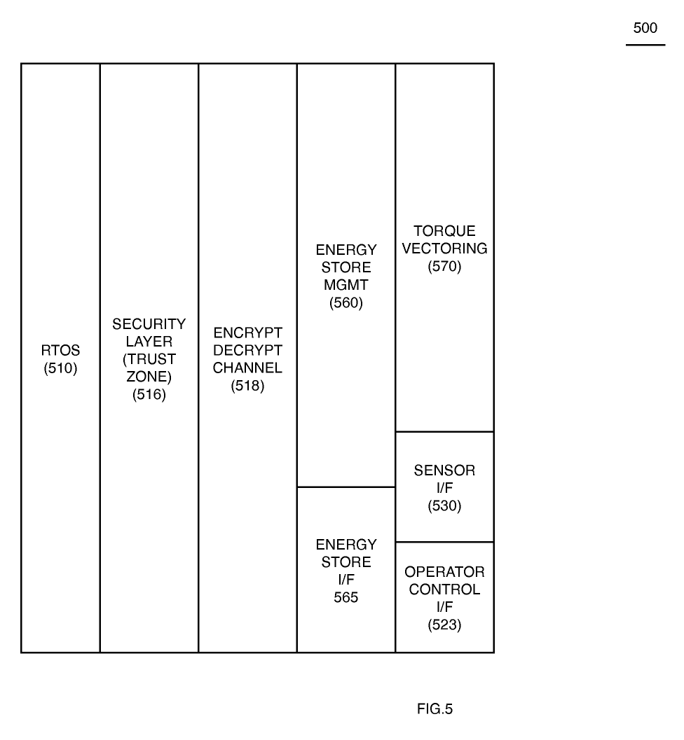

Referring now to FIG. 4, the secure vehicle control network 490 also includes a thin client PHY circuit 496; the PHY coupled to the signal propagation medium; and to, a thin client real-time USB 2 or real time USB 3 or Ethernet remote node 497; and, an encryption/decryption circuit (coder) 498, for connection to at least one client instrument 499.

An operating system provides an encrypted application-programming interface to operate functions such as torque vectoring, cooling, braking, and battery management. In embodiments, the system also includes Electronic ABS circuit; Stability Control circuit; Brake force distribution; and a Regenerative braking circuit. A real-time performance monitoring sub-system includes hardware performance counters to track micro-architectural resource usage. From this, a component utilizes performance curves and various resource usage models, including predictions of cache occupancy to optimize task execution.

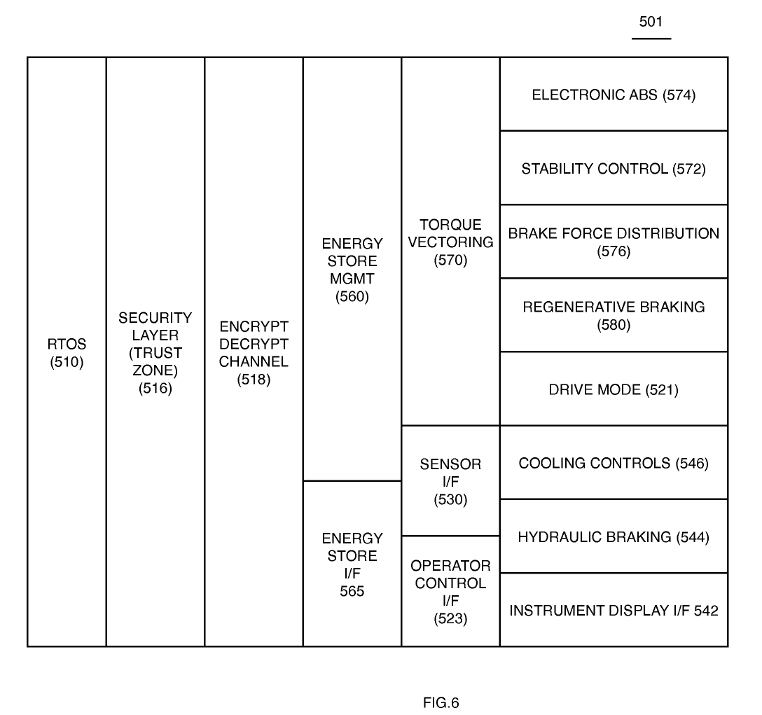

The OS provides an isolating trust zone core to each layer or application for authentication and validation. Referring now to FIG. 5, a modular vehicle control unit 500 includes a processor coupled to a non-transitory instruction store, which performs a real time operating system (RTOS) 510; a security layer to provide at least one trust zone 516; an encryption/decryption channel to transmit and receive data and controls over a secure vehicle control network; an energy store management module 560; an energy store interface 565; an operator control interface 523; a sensor interface 530; and a torque vectoring module 570.

With the new modularity, upgrades are available to install new features or improvements asynchronously from a vehicle product cycle.

Referring now to FIG.6, the modular vehicle control unit also includes 580 Regenerative braking—all 4 wheels for regen braking; 576 Brake Force Distribution—Electronic Stability Control in some circles; 574 Electronic ABS—this is the ABS logic for braking that uses the electric motors; 572 Stability Control—to dampen oscillations due to driver overcorrection; 546 Cooling Interface—connections to the battery, inverters, and other systems; 544 Hydraulic Braking Interface—interface to the hydraulic braking system for monitoring and knowing when engaged; Instrument Display Interface 542—outputs to the Infotainment display system, covers all systems; Drive Mode Inputs 521—Settings from the driver on the style of driving and settings; wherein the Sensor Interface receives measured Motion, Accelerometers, and wheel spin sensor inputs. In an embodiment, the invention includes a modular vehicle control unit (VCU) having a multi-core CPU coupled to a non-transitory instruction store causing the CPU to perform running a mixed criticality OS; a security layer based on isolated trust zone cores of the multi-core CPU; an encryption/decryption channel to transmit and receive data and controls over a secure vehicle control network; an energy store management module; an energy store interface; an operator control interface; a sensor interface; and a torque-vectoring module. In an embodiment the invention also has a regenerative braking controller on all 4 wheels for regenerative braking by independently setting separate phase control per adaptive motor controller. In an embodiment the invention also has a Brake Force Distribution—Electronic Stability Control module by matching negative torque to avoid wheel spin and skid and optimize slippage for friction. In an embodiment the invention also has an Electronic ABS logic module for braking that uses the electric motors to apply negative torque limited by skid sensors. In an embodiment the invention also has a Stability Control module sensitive to interrupt yaw feedback whereby it dampens oscillations due to driver over correction in steering. In an embodiment the invention also has a Cooling Interface module that connects to the battery, inverters, and other systems whereby drain and charge cycles are moderated to fit within a heat dissipation envelope. In an embodiment the invention also has a Hydraulic Braking Interface to sensors coupled to a hydraulic braking system for monitoring and knowing when it is engaged. In an embodiment the invention also has an Instrument Display Interface which transmits metrics and status of all systems to the Infotainment display system. In an embodiment the invention also has a Drive Mode Inputs—Settings control panel operable by the driver-operator on the style of driving and settings of stability and throttle—brake responsivity; and a virtual CPU setting control panel to budget availability of physical cores and number of cycles during each session that a physical core is available to a virtual CPU. In an embodiment the Sensor Interface receives measured Motion, Accelerometers, and wheel spin sensor inputs.

In an embodiment, the system also includes Drive Mode circuit set within the operator control; Cooling control circuits 460; Hydraulic braking circuit 440; and an Instrument display interface 420. Independent developers may test and furnish new capabilities without exposing or corrupting the IP of other vehicle modalities.

In an embodiment, the indicia received from the at least one sensor is a measure of at least one of acceleration, wheel spin, road traction, and skidding.

In an embodiment, the indicia received from the operator control interface is a measure of at least one of desired vehicle direction, desired vehicle acceleration, desired vehicle speed, and mode of vehicle behavior.

In an embodiment, the VCU receives indicia from the energy store and from the operator control interface to determine optimal energy efficiency for each inverter.

In an embodiment, the system also includes: Electronic ABS circuit; Stability Control circuit; Brake force distribution; and a Regenerative braking circuit.

Another aspect of the invention is a modular vehicle control unit which includes a processor coupled to a non-transitory instruction store, which performs a real time operating system (RTOS); a security layer to provide at least one trust zone; an encryption/decryption channel to transmit and receive data and controls over a secure vehicle control network; an energy store management module; an energy store interface; an operator control interface; a sensor interface; and a torque vectoring module.

In an embodiment, the modular vehicle control unit also includes Hydraulic Braking Interface—interface to the hydraulic braking system for monitoring and knowing when engaged.

In an embodiment, the modular vehicle control unit also includes Instrument Display Interface—outputs to the Infotainment display system, covers all systems.

In an embodiment, the modular vehicle control unit also includes Drive Mode Inputs—Settings from the driver on the style of driving and settings.

In an embodiment, the Sensor Interface receives measured Motion, Accelerometers, and wheel spin sensor inputs.

Another aspect of the invention is a secure vehicle control network (SVCN) having: a medium; the medium coupled to, a PHY circuit; the PHY circuit coupled to, a layer 2 real-time USB 2 or real time USB 3 or real time Ethernet circuit controller; coupled to an encryption/decryption circuit (coder); and, the coder coupled to, a vehicle control unit comprising a processor performing a real time operating system and trust zone layer.

In an embodiment, the secure vehicle control network also has a thin client PHY circuit; the PHY coupled to the medium and to, a thin client real-time USB 2 or real time USB 3 or Ethernet remote node; and, an encryption/decryption circuit (coder), for connection to at least one client instrument.

### CONCLUSION

The invention can be easily distinguished from conventional vehicle powertrains that have two or three differentials. Advantageously, upgrades are available to install new features or improvements after a vehicle is in the field. Independent developers may test and furnish new capabilities without exposing or corrupting the IP of other vehicle modalities.

The invention can be easily distinguished from conventional vehicle control subsystems that are subject to the inertial mass of its engine, transmission, axles, differentials, and drive shafts.

The invention can be easily distinguished from conventional vehicle personality or performance that are hardware defined.

The invention can be easily distinguished from conventional vehicle handling that may be too crisp or unstable for some drivers and too slow or boat like for other drivers.

The invention can be easily distinguished from conventional vehicle subsystems that depend on distributed control units or microprocessors throughout the vehicle.

The invention can be easily distinguished from conventional vehicle networks and control subsystem that depend on multiple embedded controllers.

The invention can be easily distinguished from conventional vehicle networks and control subsystem which suffer congestion and latency problems as more intelligence is expected in future vehicle designs.

The techniques described herein can be implemented in digital electronic circuitry, or in computer hardware, firmware, software, or in combinations of them. The techniques can be implemented as a computer program product, i.e., a computer program tangibly embodied in a non-transitory information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; internal hard disks or removable disks. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used. Accordingly, other embodiments are within the scope of the following claims.

1. A modular vehicle control unit (VCU) comprising:
a multi-core CPU coupled to a non-transitory instruction store causing the CPU to perform running a mixed criticality OS;
a security layer based on isolated trust zone cores of the multi-core CPU;
an encryption/decryption channel to transmit and receive data and controls over a secure vehicle control network;
an energy store management module;
an energy store interface;
an operator control interface;
a sensor interface; and
a torque-vectoring module.

2. The modular vehicle control unit (VCU) of claim 1 further comprising:
a regenerative braking controller on all 4 wheels for regenerative braking by independently setting separate phase control per adaptive motor controller.

3. The modular vehicle control unit of claim 1 further comprising:
a Brake Force Distribution—Electronic Stability Control module by matching negative torque to avoid wheel spin and skid and optimize slippage for friction.

4. The modular vehicle control unit of claim 1 further comprising:
an Electronic ABS logic module for braking that uses the electric motors to apply negative torque limited by skid sensors.

5. The modular vehicle control unit of claim 1 further comprising:
a Stability Control module sensitive to interrupt yaw feedback whereby it dampens oscillations due to driver over correction in steering.

6. The modular vehicle control unit of claim 1 further comprising:
a Cooling Interface module that connects to the battery, inverters, and other systems whereby drain and charge cycles are moderated to fit within a heat dissipation envelope.

7. The modular vehicle control unit of claim 1 further comprising:
a Hydraulic Braking Interface to sensors coupled to a hydraulic braking system for monitoring and knowing when it is engaged.

8. The VCU of claim 2 further comprising:
an Instrument Display Interface which transmits metrics and status of all systems to the Infotainment display system.

9. The VCU of claim 1 further comprising:
a Drive Mode Inputs—Settings control panel operable by the driver-operator on the style of driving and settings of stability and throttle—brake responsivity; and
a virtual CPU setting control panel to budget availability of physical cores and number of cycles during each session that a physical core is available to a virtual CPU.

10. The VCU of claim 1 wherein the Sensor Interface receives measured Motion, Accelerometers, and wheel spin sensor inputs.
